(19) United States
(12) Patent Application Publication
(10) Pub. No.: US 2017/0302833 A1
(43) Pub. Date: Oct. 19, 2017

(54) IMAGE PROJECTION AND CAPTURE WITH SIMULTANEOUS DISPLAY OF LED LIGHT

(71) Applicant: Hewlett-Packard Development Company, L.P., Houston, TX (US)

(72) Inventors: David Bradley Short, San Diego, CA (US); Robert L Mueller, San Diego, CA (US); Jinman Jang, San Diego, CA (US); Otto Sievert, Oceanside, CA (US); Kurt Spears, Fort Collins, CO (US)

(21) Appl. No.: 15/509,799

(22) PCT Filed: Sep. 10, 2014
(86) PCT No.: PCT/US2014/054904

§ 371 Date: Mar. 8, 2017

(51) Int. Cl. H04N 5/225; H04N 9/31; H04N 5/235; H04N 5/232

(52) U.S. Cl. CPC H04N 5/2256; H04N 9/3194; H04N 9/3176; H04N 9/3164; H04N 9/3155; H04N 5/2252; H04N 9/3105; H04N 5/2354; H04N 5/23293; H04N 9/3111

(57) ABSTRACT

A projection capture system includes a camera to capture video of objects in a capture space, and a light emitting diode (LED) projector to illuminate the objects in the capture space and to project images captured by the camera into a display space. The projector includes a sequential display mode for sequentially displaying red, green, and blue light to project images captured by the camera into the display space, and a camera flash mode for simultaneously displaying red, green, and blue light to provide white light for illuminating the objects in the capture space during video capture.

### BACKGROUND

Sharing digital information and collaborating based on that digital information is becoming increasingly common. Input devices capture digital information (e.g., user input on a computing device, digital cameras, scanning devices, etc.). Output devices output digital information for consumption by a user or group of users. Output devices may include digital displays or digital projectors that display digital information onto a display screen or into a workspace.

### BRIEF DESCRIPTION OF THE DRAWINGS

FIGS. 1A and 1B are diagrams illustrating perspective exterior views of one example of a projection capture system.

FIG. 2 is a diagram illustrating a perspective interior view of one example of a projection capture system.

FIG. 3 is a block diagram illustrating the projection capture system shown in FIG. 2 according to one example.

FIG. 4 is a flow diagram illustrating a method for capturing and projecting images according to one example.

### DETAILED DESCRIPTION

In the following detailed description, reference is made to the accompanying drawings which form a part hereof, and in which is shown by way of illustration specific examples in which the disclosure may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. It is to be understood that features of the various examples described herein may be combined, in part or whole, with each other, unless specifically noted otherwise.

One example is directed to a projection capture system that improves the interactive user experience working with real objects and projected objects on a physical work surface. The system is implemented, for example, in stand-alone portable devices deployed on an ordinary work surface. A digital camera, projector and control programming are housed together in a desktop unit that enables a projection augmented virtual reality in which real and projected/virtual objects can be manipulated and shared simultaneously among multiple remote users. Such portable devices can be deployed almost anywhere at any time for interactive collaboration across a comparatively inexpensive platform suitable not only for larger, enterprise business environments but also for small businesses and even personal consumers.

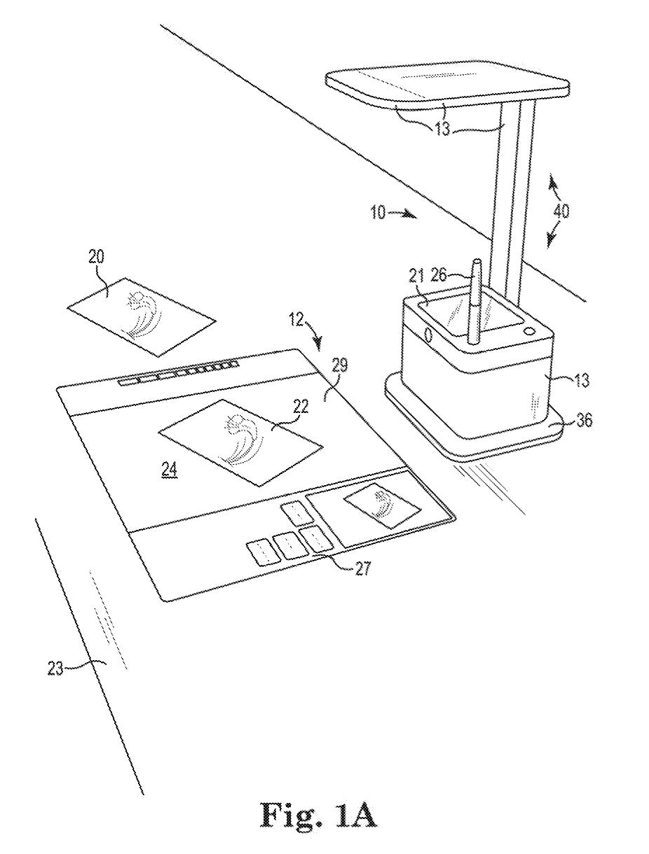

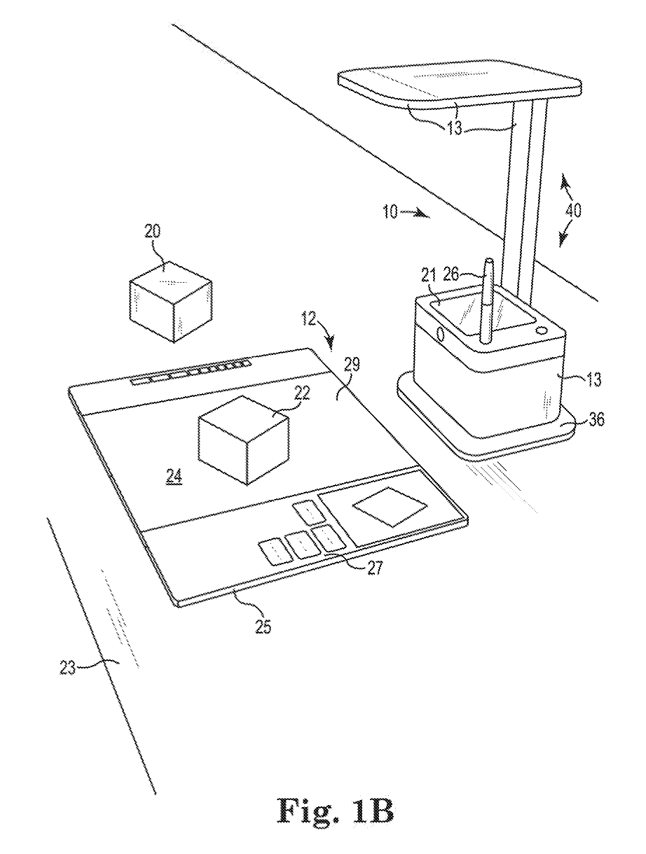

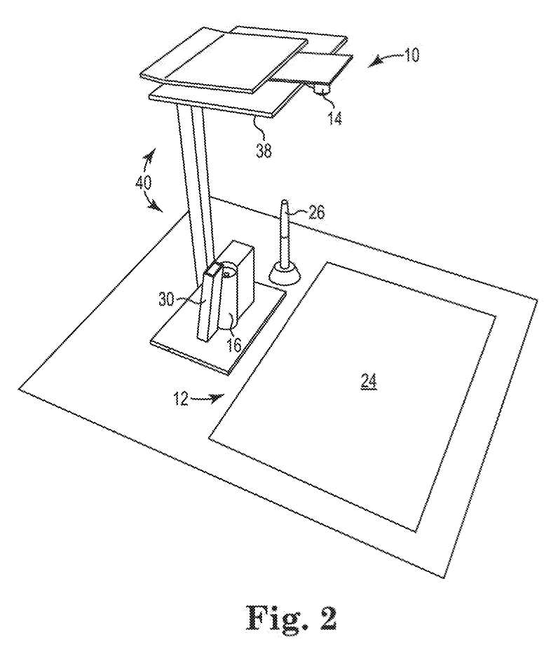

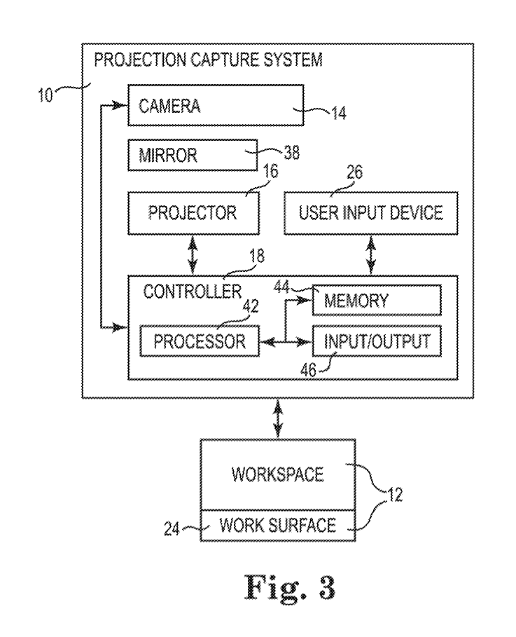

FIGS. 1A and 1B are diagrams illustrating perspective exterior views of one example of a projection capture system 10 and an interactive workspace 12 associated with system 10. FIG. 2 is a diagram illustrating a perspective view of one example of a projection capture system 10 with exterior housing 13 removed. FIG. 3 is a block diagram of system 10 shown in FIG. 2 according to one example. Referring to FIGS. 1A, 1B, 2, and 3, projection capture system 10 includes a digital camera 14, a projector 16, and a controller 18. Camera 14 and projector 16 are operatively connected to controller 18 for camera 14 capturing an image of an object 20 in workspace 12 and for projector 16 projecting the object image 22 into workspace 12 and, in some examples, for camera 14 capturing an image of the projected object image 22. The lower part of housing 13 includes a transparent window 21 over projector 16 (and infrared camera 30).

In the example shown in FIG. 1A, a two dimensional object 20 (e.g., a hardcopy photograph) placed onto a work surface 24 in workspace 12 has been photographed by camera 14 (FIG. 2). Object 20 has then been removed to the side of workspace 12, and object image 22 has been projected onto work surface 24, where it can be photographed by camera 14 and/or otherwise manipulated by a user and re-projected into workspace 12. In the example shown in FIG. 1B, a three dimensional object 20 (e.g., a cube) placed onto work surface 24 has been photographed by camera 14. Object 20 has then been removed to the side of workspace 12, and object image 22 has been projected into workspace 12 where it can be photographed by camera 14 and/or otherwise manipulated by a user and re-projected into workspace 12.

In one example implementation of system 10, controller 18 is programmed and projector 16 is to project object image 22 into the same position in workspace 12 as the position of object 20 when its image was captured by camera 14. Thus, a one-to-one scale digital duplicate 22 of an object 20 can be projected over the original allowing a digital duplicate in its place to be manipulated, moved, and otherwise altered as desired by a local user or by multiple remote users collaborating in the same projected workspace 12. The projected image can also be shifted away from the original, allowing a user to work with the original and the duplicate together in the same workspace 12.

System 10 also includes a user input device 26 that allows the user to interact with system 10. A user may interact with object 20 and/or object image 22 in workspace 12 through input device 26. Object image 22 may be transmitted to other workspaces 12 on remote systems 10 (not shown) for collaborative user interaction, and, if desired, object image 22 may be photographed by camera 14 and re-projected into local and/or remote workspaces 12 for further user interaction. In FIG. 1A, work surface 24 is part of the desktop or other underlying support structure 23. In FIG. 1B, work surface 24 is on a portable mat 25 that may include touch sensitive areas. In FIG. 1A, for example, a user control panel 27 is projected on to work surface 24, while in FIG. 1B, control panel 27 may be embedded in a touch sensitive area of mat 25. Similarly, an A4, letter or other standard size document placement area 29 may be projected onto work surface 24 in FIG. 1A or printed on mat 25 in FIG. 1B. Other configurations for work surface 24 are possible. For example, in some applications, system 10 may use an otherwise blank mat 25 to control the color, texture, or other characteristics of work surface 24, and thus control panel 27 and document placement area 29 may be projected on to the blank mat 25 in FIG. 1B just as they are projected on to the desktop 23 in FIG. 1A.

In one example implementation of system 10, projector 16 serves as the light source for camera 14. A camera capture area and a projector display area overlap on work surface 24. Thus, a substantial operating efficiency can be gained using projector 16 both for projecting images and for camera lighting. The light path from projector 16 through workspace 12 to work surface 24 is positioned with respect to camera 14 to enable user display interaction with minimal shadow occlusion while avoiding specular glare off work surface 24 and objects in workspace 12 that would otherwise blind camera 14.

In one example, the components of system 10 are housed together as a single device 40. Referring to FIG. 3, to help implement system 10 as an integrated standalone device 40, controller 18 includes a processor 42, a memory 44, and an input/output 46 housed together in device 40. Input/output 46 allows device 40 to receive information from and send information to an external device. While input/output 46 is shown in FIG. 3 as being part of controller 18, some or all of input/output 46 could be separate from controller 18.

For the configuration of controller 18 shown in FIG. 3, the system programming to control and coordinate the functions of camera 14 and projector 16 may reside substantially on controller memory 44 for execution by processor 42, thus enabling a standalone device 40 and reducing any special programming of camera 14 and projector 16. Programming for controller 18 may be implemented in any suitable form of processor executable medium including software modules, hardware modules, special-purpose hardware (e.g., application specific hardware, application specific integrated circuits (ASICs), embedded controllers, hardwired circuitry, etc.), or some combination of these. Also, while other configurations are possible, for example where controller 18 is formed in whole or in part using a computer or server remote from camera 14 and projector 16, a compact standalone appliance such as device 40 shown in FIGS. 1A, 1B and 2 offers the user full functionality in an integrated, compact mobile device 40.

System 10 may also have additional features/functionality. For example, system 10 may also include additional storage (removable and/or non-removable) including, but not limited to, magnetic or optical disks or tape. Computer-readable storage media includes volatile and nonvolatile, removable and non-removable media implemented in any suitable method or technology for non-transitory storage of information such as computer readable instructions, data structures, program modules or other data. Memory 44 is an example of computer-readable storage media (e.g., computer-readable storage media storing computer-executable instructions that when executed by at least one processor cause the at least one processor to perform a method). Computer-readable storage media includes RAM, ROM, EEPROM, flash memory or other memory technology. CD-ROM, digital versatile disks (DVD) or other optical storage, magnetic cassettes, magnetic tape, magnetic disk storage or other magnetic storage devices, or any other non-transitory medium that can be used to store the desired information and that can be accessed by system 10. Any such computer-readable storage media may be part of system 10.

While camera 14 represents generally any suitable digital camera for selectively capturing still and video images in workspace 12, it is expected that a high resolution digital camera will be used in most applications for system 10. A “high resolution” digital camera as used in this document means a camera having a sensor array of at least 12 megapixels. Lower resolution cameras may be acceptable for some basic scan and copy functions, but resolutions below 12 megapixels currently are not adequate to generate a digital image sufficiently detailed for a full range of manipulative and collaborative functions. Small size, high quality digital cameras with high resolution sensors are now quite common and commercially available from a variety of camera makers. A high resolution sensor paired with the high performance digital signal processing (DSP) chips available in many digital cameras affords sufficiently fast image processing times, for example a dick-to-preview time of less than a second, to deliver acceptable performance for most system 10 applications.

The example configuration for system 10 integrated into a standalone device 40 shown in the figures and described above achieves a desirable balance among product size, performance, usability, and cost. The system 10 includes a mirror 38 for producing a folded light path in which light is projected generally upward from projector 16, and reflected generally downward onto work surface 24 by mirror 38. The folded light path for projector 16 reduces the height of device 40 while maintaining an effective placement of the projector high above workspace 12 to prevent specular glare in the capture area of camera 12. The projector's light path shines on a horizontal work surface 24 at a steep angle enabling 3D object image capture. This combination of a longer light path and steep angle minimizes the light fall off across the capture area to maximize the light uniformity for camera flash. In addition, the folded light path enables the placement of projector 16 near base 36 for product stability.

Since projector 16 acts as the light source for camera 14 for still and video capture, the projector light is bright enough to swamp out any ambient light that might cause defects from specular glare. It has been determined that a projector light 200 lumens or greater is sufficiently bright to swamp out ambient light for the typical desktop application for system 10 and device 40. For video capture and real-time video collaboration, projector 16 shines white light into workspace 12 to illuminate object(s) 20. In one example, for a light emitting diode (LED) projector 16, the time sequencing of the red, green, and blue LED's that make up the white light are synchronized with the video frame rate of camera 14. The refresh rate of projector 16 and each LED sub-frame refresh period is an integral number of the camera's exposure time for each captured frame to avoid “rainbow banding” and other unwanted effects in the video image. Also, the camera's video frame rate may be synchronized with the frequency of any ambient fluorescent lighting that typically flickers at twice the AC line frequency (e.g., 120 Hz for a 60 Hz AC power line). An ambient light sensor can be used to sense the ambient light frequency and adjust the video frame rate for camera 14 accordingly.

In another example, the camera 14 and the projector 16 are not synchronized. In one form of this example, a method is used for removing optical beating artifacts from an image or video stream projected by the projector 16. In one form of this example, a camera flash mode is used that replaces the time sequential red, green, blue lighting sequence with a mode that turns each LED on at the same time at a 100% duty cycle, as described in further detail below.

LED projectors typically include three color LED light sources that display light in a red, green, blue time sequential pattern. When using this light source as an illumination system for camera capture or video capture, a rainbow or gray scale beating artifact can be introduced. Typically, the projector displays white light by interleaving red, green and blue light at such a high frequency that the human eye integrates the discrete colors into a uniform white light.

Cameras with rolling shutters operating at high frame rates will be able to detect this time sequential R,G,B color sequence. It will be presented as a series of rainbow colored bars in the captured image, even when the projector is projecting white light. To avoid this artifact, the camera's frame rate can be significantly decreased so that each frame exposure includes multiple frames of projected light. However, this may lead to a poor user experience and allow for motion blur artifacts to be introduced into the captured image.

Typically, the red, green and blue LEDs are on for a fixed percentage of time during each displayed frame of content. White light is made by adjusting these percentages (e.g., red is on 40%, blue is on 20% and green is on 40% of the time) for a single frame. This on-off cycle is what creates the artifact in the image capture system. By changing from a time based modulation of the light output to an intensity based modulation in the camera flash mode, the same white color can be achieved, but with each LED on 100% of the time during the camera flash mode. In the camera flash mode, no color is displayed by the projector (i.e., only white light), but the introduction of the color beating artifacts is also eliminated. Furthermore, by displaying a solid white image, grayscale beating can also be eliminated.

In some systems, a completely separate illumination system may be added to enable “flash” illumination of the capture scene, which is costly and complicated. In contrast, in one example herein, a software system including machine-readable instructions is used to create the camera flash mode that replaces the time sequential red, green, blue lighting sequence with a mode that turns each LED on at a 100% duty cycle, so that all three LEDs are projecting at the same time during the entire camera flash mode. In one example, the camera flash mode is defined and created in the firmware of the projector 16, which comprises machine-readable instructions, and is subsequently enabled by a functional call to the projector 16 requesting the camera flash mode. The functional call results in the normal sequential display signal being provided to the projector 16 to be interrupted, and replaced with a signal that causes the red, green, and blue LEDs to all project light at the same time. In one example, the camera flash mode lasts for a predetermined period of time, and then the projector 16 is to automatically return to a normal sequential display mode. In another example, a second functional call is made to the projector 16 to instruct the projector 16 to switch from the camera flash mode to the normal sequential display mode. During the camera flash mode, the camera 14 captures an image or multiple images (e.g., video), using the white light from the projector 16 as an illumination source. The length of the camera flash mode may vary based on whether a single frame is being captured or whether multiple frames are being captured. In one example, current to the LEDs is individually controlled to set the value of the brightness of each LED to achieve a true white point during the camera flash mode.

This method does not use a separate illumination system, and makes use of existing hardware to accomplish the functionality without adding cost, complexity, and size. The existing hardware is used as both a projected display device and also as a high powered camera flash device. The method works for a variety of different types of image sensors, including global shutter sensors and rolling shutter sensors. Since all of the LEDs are providing light at the same time in the camera flash mode, an overall brighter light is provided than during the normal sequential mode, which reduces the sensitivity of the system to any ambient light.

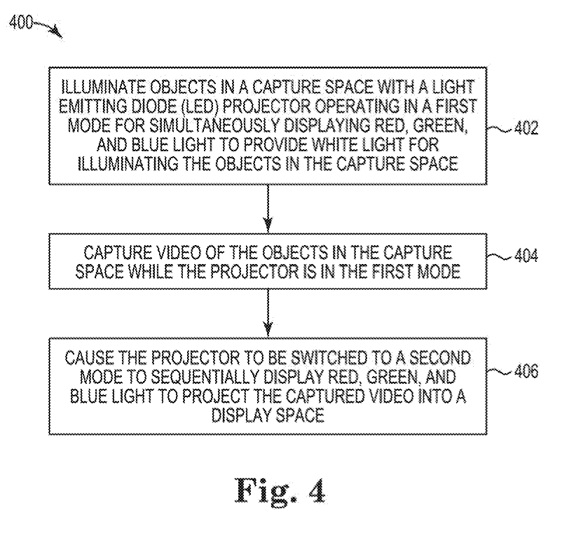

One example implementation is directed to a method for capturing and projecting images. FIG. 4 is a flow diagram illustrating the method according to one example. At 402 in method 400, objects in a capture space are illuminated with a light emitting diode (LED) projector operating in a first mode for simultaneously displaying red, green, and blue light to provide white light for illuminating the objects in the capture space. At 404, video of the objects in the capture space is captured while the projector is in the first mode. At 406, the projector is caused to be switched to a second mode to sequentially display red, green, and blue light to project the captured video into a display space.

In one form of method 400, the currents to red, green, and blue LEDs of the projector are individually controlled to set a value of the brightness of each LED to achieve a true white point during the first mode. The display space in method 400 overlaps the capture space in one example. The projector in method 400, according to one example, is housed together with a camera that captures the images of the objects. In one form of this example, the camera is positioned above the projector and the method further comprises: reflecting, with a mirror positioned above the projector, light from the projector down onto the display space.

Another example implementation is directed to a projection capture system that includes a camera to capture video of objects in a capture space, and a light emitting diode (LED) projector to illuminate the objects in the capture space and to project images captured by the camera into a display space. The projector includes a sequential display mode for sequentially displaying red, green, and blue light to project images captured by the camera into the display space, and a camera flash mode for simultaneously displaying red, green, and blue light to provide white light for illuminating the objects in the capture space during video capture.

In one form of this example, the projector switches between the sequential display mode and the camera flash mode based on a functional call sent to the projector. In one implementation, the projector automatically exits the camera flash mode and returns to the sequential display mode after a predetermined period of time. In another implementation, the projector exits the camera flash mode and returns to the sequential display mode in response to receiving a functional call. Currents to red, green, and blue LEDs of the projector are individually controlled to set a value of the brightness of each LED during the camera flash mode. In one example, currents to red, green, and blue LEDs of the projector are individually controlled to set a value of the brightness of each LED during the camera flash mode to achieve a true white point. The display space overlaps the capture space. The projector is housed together with the camera. The camera is positioned above the projector and the system includes a mirror positioned above the projector to reflect light from the projector down onto the display space.

Yet another example implementation is directed to a computer-readable storage media storing computer-executable instructions that when executed by at least one processor cause the at least one processor to perform a method. The method includes causing a light emitting diode (LED) projector to enter a camera flash mode to illuminate objects in a capture space by simultaneously displaying red, green, and blue light to provide white light. The method further includes causing a camera to capture video of the objects in the capture space while the projector is in the camera flash mode, and causing the projector to switch to a sequential display mode to sequentially display red, green, and blue light to project the captured video into a display space.

Although specific examples have been illustrated and described herein, a variety of alternate and/or equivalent implementations may be substituted for the specific examples shown and described without departing from the scope of the present disclosure. This application is intended to cover any adaptations or variations of the specific examples discussed herein. Therefore, it is intended that this disclosure be limited only by the claims and the equivalents thereof.

1. A projection capture system, comprising;
a camera to capture video of objects in a capture space; and
a light emitting diode (LED) projector to illuminate the objects in the capture space and to project images captured by the camera into a display space, wherein the projector includes a sequential display mode for sequentially displaying red, green, and blue LED light to project images captured by the camera into the display space, and a camera flash mode for simultaneously displaying red, green, and blue LED light to provide white light for illuminating the objects in the capture space during video capture.

2. The system of claim 1, wherein the projector switches between the sequential display mode and the camera flash mode based on a functional call sent to the projector.

3. The system of claim 2, wherein the projector automatically exits the camera flash mode and returns to the sequential display mode after a predetermined period of time.

4. The system of claim 2, wherein the projector exits the camera flash mode and returns to the sequential display mode in response to receiving a functional call.

5. The system of claim 1, wherein currents to red, green, and blue LEDs of the projector are individually controlled to set a value of the brightness of each LED during the camera flash mode.

6. The system of claim 1, wherein currents to red, green, and blue LEDs of the projector are individually controlled to set a value of the brightness of each LED during the camera flash mode to achieve a true white point.

7. The system of claim 1, wherein the display space overlaps the capture space.

8. The system of claim 1, wherein the projector is housed together with the camera.

9. The system of claim 1, wherein the camera is positioned above the projector and wherein the system further comprises a mirror positioned above the projector to reflect light from the projector down onto the display space.

10. A method for capturing and projecting images, comprising:
illuminating objects in a capture space with a light emitting diode (LED) projector operating in a first mode for simultaneously displaying red, green, and blue LED light to provide white light for illuminating the objects in the capture space;
capturing video of the objects in the capture space while the projector is in the first mode; and
causing the projector to switch to a second mode to sequentially display red, green, and blue LED light to project the captured video into a display space.

11. The method of claim 10, and further comprising:
individually controlling currents to red, green, and blue LEDs of the projector to set a value of the brightness of each LED to achieve a true white point during the first mode.

12. The method of claim 10, wherein the projector is housed together with a camera that captures the images of the objects.

13. The method of claim 12, wherein the camera is positioned above the projector and wherein the method further comprises:
reflecting, with a mirror positioned above the projector, light from the projector down onto the display space.

14. A computer-readable storage media storing computer-executable instructions that when executed by at least one processor cause the at least one processor to perform a method, comprising:
causing a light emitting diode (LED) projector to enter a camera flash mode to illuminate objects in a capture space by simultaneously displaying red, green, and blue LED light to provide white light;
causing a camera to capture video of the objects in the capture space while the projector is in the camera flash mode; and
causing the projector to switch to a sequential display mode to sequentially display red, green, and blue LED light to project the captured video into a display space.

15. The computer-readable storage media of claim 14, wherein the display space overlaps the capture space.
